(19) United States
(12) Patent Application Publication
(10) Pub. No.: US 2021/0188320 A1
(43) Pub. Date: Jun. 24, 2021

(54) METHOD FOR ESTIMATING LOCATION OF OBJECT, AND APPARATUS THEREFOR

(71) Applicant: SAMSUNG ELECTRONICS CO., LTD., Suwon-si, Gyeonggi-do (KR)

(72) Inventors: Jinseob KIM, Suwon-si, Gyeonggi-do (KR); Hun LEE, Suwon-si, Gyeonggi-do (KR); Jinsung KIM, Suwon-si, Gyeonggi-do (KR)

(21) Appl. No.: 17/057,538

(22) PCT Filed: May 20, 2019
(86) PCT No.: PCT/KR2019/005989

§ 371 Date: Nov. 20, 2020

(30) Foreign Application Priority Data
May 21, 2018 (KR) 10-2018-0057991

(51) Int. Cl. B60W 60/00; H04W 4/02; H04W 4/024; H04W 4/80; H04W 4/44; G05B 13/02; B60W 30/09; B60W 50/06

(52) U.S. Cl. CPC B60W 60/0016; H04W 4/023; H04W 4/024; B60W 50/06; H04W 4/44; G05B 13/027; B60W 30/09; H04W 4/80

(57) ABSTRACT

The disclosure relates to a method of estimating a location of an object and an apparatus therefor. According to an embodiment of the disclosure, an object location estimation apparatus, when a call request to an object is received from a terminal, initiates driving along a driving path, receives signals from the object during driving along the driving path, determines a distance to the object based on the signals from the object, and when the signals from the object are received the preset number of times or more during driving, estimates the location of the object based on the distance to the object determined based on each of the signals and a location on the driving path at a time of receiving each signal.

### TECHNICAL FIELD

The disclosure relates to a method and apparatus for estimating a location of an object.

### BACKGROUND ART

As the era of the fourth industrial revolution approaches, it is predicted that, with the development of various sensors and big data processing techniques, robots will perform tasks that human beings have previously performed. As a representative example, as technologies such as autonomous driving, etc. have developed, technology has been developed for providing services by robots, devices, etc. that visit a requested place even when human beings do not visit a place in which a service is provided to receive the service.

To this end, it is essential to develop a technique for estimating a location desired by a user and moving a robot, a device, etc. to the estimated location. However, according to existing studies on the above technique, further development in technology is required because installation of additional infrastructure, e.g., an expensive sensor, etc. is necessary, or the accuracy of estimating the location may degrade when the installation of infrastructure is not required.

### DESCRIPTION OF EMBODIMENTS

### Technical Problem

Provided are a method and apparatus for estimating a location of an object while reducing addition or change in infrastructure.

### Solution to Problem

The disclosure relates to a method of estimating a location of an object and an apparatus therefor. According to an embodiment of the disclosure, an object location estimation apparatus, when a call request to an object is received from a terminal, initiates driving along a driving path, receives signals from the object during driving along the driving path, determines a distance to the object based on the signals from the object, and when the signals from the object are received the preset number of times or more during driving, estimates the location of the object based on the distance to the object determined based on each of the signals and a location on the driving path at a time of receiving each signal.

### BRIEF DESCRIPTION OF DRAWINGS

FIG. 1 is a conceptual diagram illustrating an object location estimation system according to an embodiment of the disclosure.

FIG. 2 is a flowchart illustrating a method of estimating an object location according to an embodiment of the disclosure.

FIG. 3 is a diagram for describing a method of estimating an object location based on locations from which signals are received, performed by an object location estimation apparatus according to an embodiment of the disclosure.

FIG. 4 is a diagram for describing a method of estimating an object location based on locations from which signals are received, performed by an object location estimation apparatus according to another embodiment of the disclosure.

FIG. 5 is a diagram for describing a method of determining a driving path by using a training network model, performed by an object location estimation apparatus according to an embodiment of the disclosure.

FIG. 6 is a flowchart illustrating a method of estimating an object location according to another embodiment of the disclosure.

FIG. 7 is a diagram for describing a method of estimating an object location through NFC tagging and image recognition, performed by an object location estimation apparatus according to an embodiment of the disclosure.

FIG. 8 is a block diagram of an object location estimation apparatus according to an embodiment of the disclosure.

FIG. 9 is a diagram illustrating a processor according to an embodiment of the disclosure.

FIG. 10 is a block diagram of a data learning unit according to an embodiment of the disclosure.

FIG. 11 is a block diagram of a data recognition unit according to an embodiment of the disclosure.

FIG. 12 is a block diagram of an object location estimation apparatus according to another embodiment of the disclosure.

### BEST MODE

According to an embodiment of the disclosure, a method of estimating an object location includes, when receiving a call request from a terminal to an object, initiating driving along a driving path, receiving a signal from the object during driving along the driving path, determining a distance from the object based on the signal transmitted from the object, and when receiving the signal from the object a set number of times or greater during the driving, estimating the location of the object based on the distance from the object based on each signal and a location on the driving path at a time of receiving each signal.

The method may further include determining the driving path based on history information about the location of the object before receiving the call request.

The method may further include determining the driving path by using a learning network model that is generated in advance based on user information and history information about the location of the object before receiving the call request, the user information including at least one of an address of a user of the object or an object using time.

The estimating of the location of the object may include determining whether a signal having a threshold intensity or greater is received the set number of times or more from the object during the driving.

The signal may include identification information of the object, and the method may further include determining whether a signal received during the driving along the driving path includes the identification information of the object.

The method may further include, when a server receives the call request from the terminal, receiving the call request from the server.

According to an embodiment of the disclosure, an object location estimation method include acquiring identification information of an object and information about a target area included in a call request from a terminal to the object, initiating driving to the target area, obtaining an image of at least one object located in the target area during the driving, and estimating the location of the object by comparing identification information recognized from the image of the at least one object with the identification information of the object.

The method may further include determining a driving path from a current location to the target area based on the information about the target area, and the obtaining of the image of at least one object may include obtaining the image of at least one object during the driving along the determined driving path.

The call request may be received from the terminal

by at least one of an NFC method, an RFID method, or a QR code method.

The method may further include receiving the call request from a server, when the server receives the call request from the terminal.

According to an embodiment of the disclosure, an apparatus for estimating an object location includes a communicator, a memory storing one or more instructions, and a processor configured to execute the one or more instructions stored in the memory, wherein the processor is further configured to execute the one or more instructions to, when receiving a call request from a terminal to an object, initiate driving along a driving path, receive a signal from the object via the communicator during driving along the driving path, determine a distance from the object based on the signal transmitted from the object, and when receiving the signal from the object a set number of times or greater during the driving, estimate the location of the object based on the distance from the object based on each signal and a location on the driving path at a time of receiving each signal.

According to an embodiment of the disclosure, an apparatus for estimating an object location includes a communicator, a memory storing one or more instructions, and a processor configured to execute the one or more instructions stored in the memory, wherein the processor is further configured to execute the one or more instructions to acquire identification information of an object and information about a target area included in a call request from a terminal to the object, initiate driving to the target area, obtain an image of at least one object located in the target area during the driving, and estimate the location of the object by comparing identification information recognized from the image of the at least one object with the identification information of the object.

### MODE OF DISCLOSURE

The terminology used herein will be described briefly, and the disclosure will be described in detail.

All terms including descriptive or technical terms which are used herein should be construed as having meanings that are obvious to one of ordinary skill in the art. However, the terms may have different meanings according to an intention of one of ordinary skill in the art, precedent cases, or the appearance of new technologies. Also, some terms may be arbitrarily selected by the applicant. In this case, the meaning of the selected terms will be described in the detailed description. Thus, the terms used herein have to be defined based on the meaning of the terms together with the description throughout the specification.

It will be understood that although the terms “first” and “second” are used herein to describe various elements, these elements should not be limited by these terms. Terms are only used to distinguish one element from other elements. For example, a second element may be referred to as a first element while not departing from the scope of the disclosure, and likewise, a first element may also be referred to as a second element. The term and/or includes a combination of a plurality of related described items or any one item among the plurality of related described items.

It will be further understood that the terms “comprises” and/or “comprising,” when used in this specification, specify the presence of stated components, but do not preclude the presence or addition of one or more components. The term “unit”, as used herein, means a software or hardware component, such as a Field Programmable Gate Array (FPGA) or Application Specific Integrated Circuit (ASIC), which performs certain tasks. However, the term “unit” is not limited to software or hardware. A “unit” may advantageously be configured to reside on the addressable storage medium and configured to execute on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and “units” may be combined into fewer components and “units” or may be further separated into additional components and “units”.

Hereinafter, one or more embodiments of the disclosure will be described in detail with reference to accompanying drawings to the extent that one of ordinary skill in the art would be able to carry out the disclosure. However, the disclosure may be implemented in various manners, and is not limited to one or more embodiments described herein. In addition, components irrelevant with the description are omitted in the drawings for clear description, and like reference numerals are used for similar components throughout the entire specification.

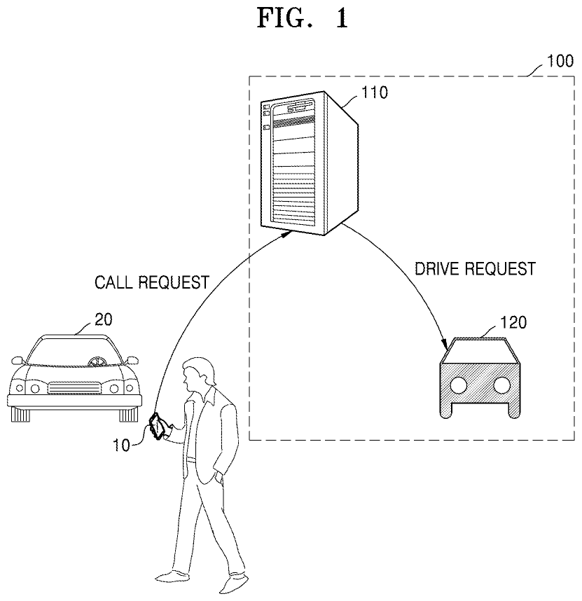

FIG. 1 is a conceptual diagram illustrating an object location estimation system 100 according to an embodiment of the disclosure.

Referring to FIG. 1, the object location estimation system 100 may include a server 110 and at least one object location estimation apparatus (e.g., 120). However, elements of the object location estimation system 100 according to the embodiment of the disclosure are not limited to the above example. According to another embodiment of the disclosure, the object location estimation system 100 may include more or less elements than the above-stated elements. For example, the object location estimation system 100 may include a plurality of servers and a plurality of object location estimation apparatuses. Also, in another example, the object location estimation system 100 may include the object location estimation apparatus 120 which may function as the server 110 that will be described later.

The server 110 may receive a call request from a user terminal 10 to an object 20. Here, the call request is generated by an input of the user, and the user may call the object location estimation apparatus via the terminal 10 in order to provide the object 20 with a service desired by the user. For example, the user may call the object location estimation apparatus by inputting at least one of identification information of the object 20 and content of the service desired by the user.

In addition, in the specification of the disclosure, the object may include such an object as a car, a bicycle, a ship, an airplane, a remote controller, etc., but is not limited thereto. Also, the service may include a refueling service, a location information providing service, a repairing service, a charging service, etc., but is not limited thereto.

When receiving a call request from the user terminal 10 to the object, the server 110 may request the object location estimation apparatus 120 to initiate driving to the object. Here, the server 110 may provide the object location estimation apparatus 120 with identification information of the object 20, such that the object location estimation apparatus 120 may identify the object 20. According to another example, the server 110 may provide the object location estimation apparatus 120 with information about a target area including a point where the object 20 is located.

When it is requested to initiate driving to the object from the server 110, the object location estimation apparatus 120 may initiate driving through a driving path. Here, the driving path may be determined in advance, or the object location estimation apparatus 120 may determine the driving path according to the identification information of the object.

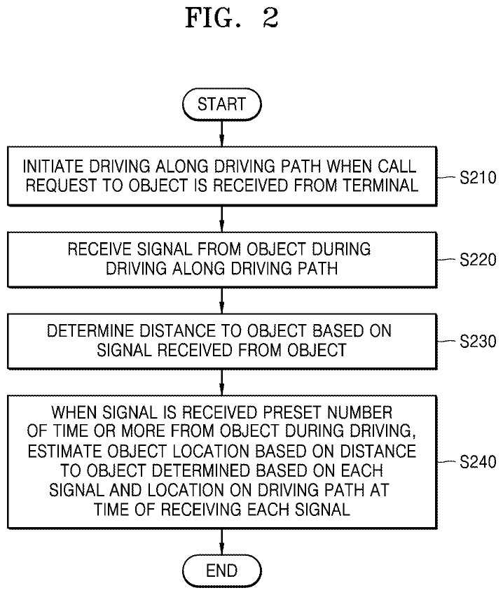

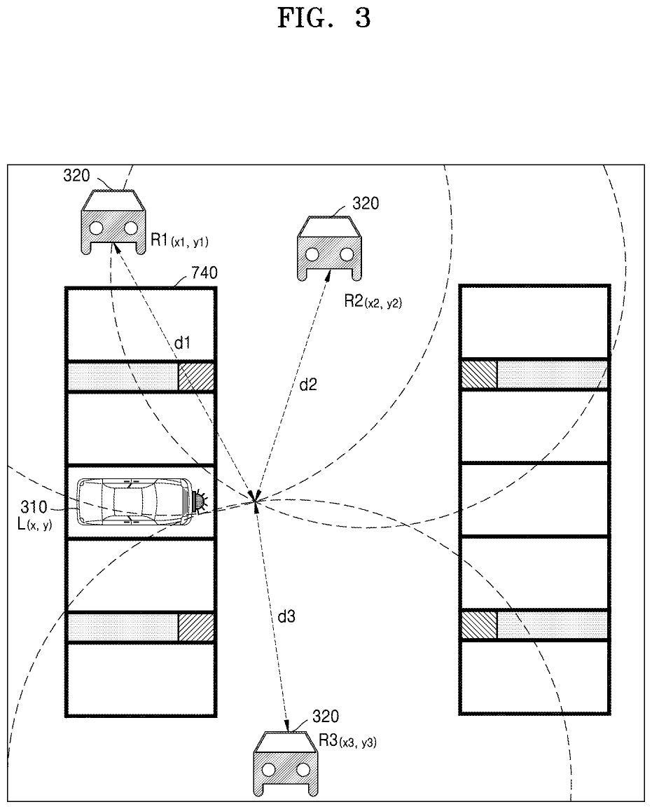

The object location estimation apparatus 120 according to the embodiment of the disclosure may estimate the location of the object 20 based on a plurality of signals received from the object 20 during the driving. For example, the object location estimation apparatus 120 may estimate the location of the object 20 based on a location on the driving path, on which each of the plurality of signals is received. This will be described in more detail below with reference to FIGS. 2 and 3.

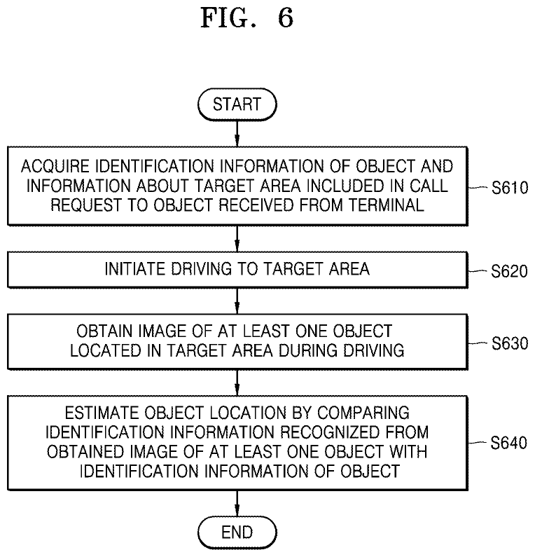

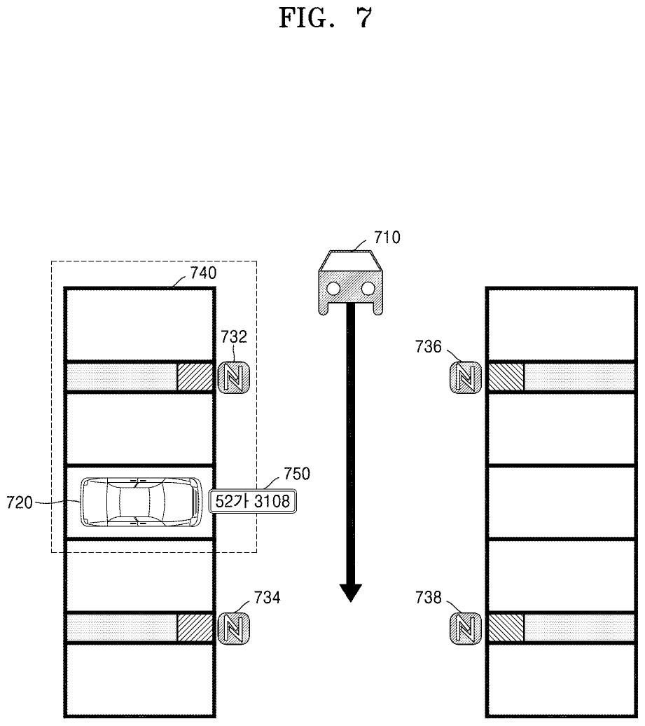

The object location estimation apparatus 120 according to another embodiment of the disclosure may estimate the location of the object 20 by comparing identification information recognized from an image of the object 20 obtained during the driving with the identification information obtained in advance. This will be described in more detail below with reference to FIGS. 6 and 7.

In addition, the object location estimation apparatus 120 may be one of a drone and a robot, but is not limited thereto. The object location estimation apparatus 120 may be implemented in another type of device that may perform an autonomous travelling function.

FIG. 2 is a flowchart illustrating a method of estimating an object location according to an embodiment of the disclosure.

In operation S210, the object location estimation apparatus may initiate driving along the driving path when receiving a call request from a terminal to the object.

The object location estimation apparatus according to the embodiment of the disclosure may receive a call request from the terminal to the object. In another embodiment, when a server receives a call request from the terminal to the object, the object location estimation apparatus may receive a driving initiate request from the server.

In the disclosure, the call request to the object may include at least one of identification information of the object, information about service, or information about a target area. The identification information of the object may include, for example, unique values by which the object may be identified, e.g., a car number, a ship number, an airplane number, etc. The service content may include, for example, information representing a kind of the service desired by the user of the terminal, e.g., an amount of oil filled in the car, a charging time, an object to be repaired, etc. The target area is an area including a point where the object is located, for example, a parking zone.

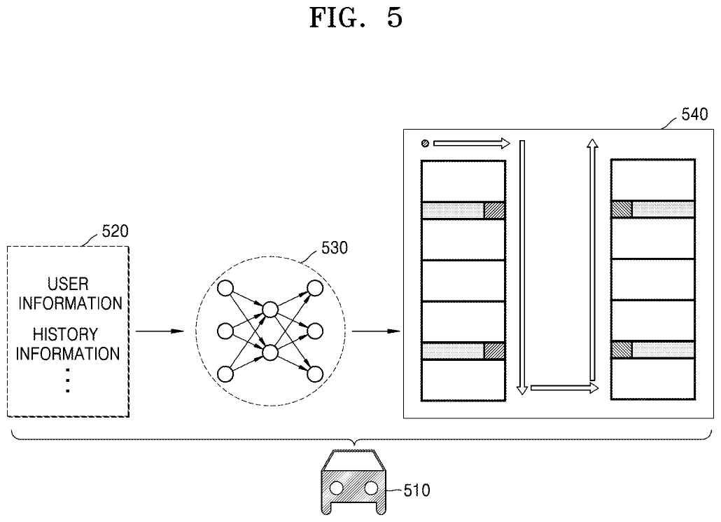

In addition, the object location estimation apparatus may determine the driving path when receiving a call request from a terminal to the object. The object location estimation apparatus according to the embodiment of the disclosure may determine a preset path as the driving path. In another embodiment of the disclosure, the object location estimation apparatus may determine the driving path based on history information about previous locations of the object stored in advance. For example, the object location estimation apparatus may determine the driving path by setting a relatively higher weight to a point where the object has been previously located, as compared with other points. According to another embodiment of the disclosure, the object location estimation apparatus may determine the driving path by using a learning network model based on user information and the history information. This will be described in more detail later with reference to FIG. 5.

In operation S220, the object location estimation apparatus may receive a signal from the object while driving along the driving path.

For example, the object location estimation apparatus may receive a beacon signal from the object during driving. However, the type of the signal received by the object location estimation apparatus from the object is not limited to the above example. According to another examples, the signal may be of various types, e.g., an infrared-ray, laser, radio waves, etc.

The object location estimation apparatus may compare the identification information of the object included in the received signal with the identification information of the object included in the call request transmitted from the terminal, and then, may determine whether the received signal corresponds to the object that the call is requested.

Also, the object location estimation apparatus may determine that the signal is effectively received only when an intensity of the received signal is equal to or greater than a threshold intensity, in order to improve an accuracy of estimating the location of the object.

In operation S230, the object location estimation apparatus may determine a distance between the object location estimation apparatus and the object based on the signal transmitted from the object.

The object location estimation apparatus according to the embodiment may determine the distance between the object and the object location estimation apparatus based on the intensity of the signal transmitted from the object. For example, when the intensity of the signal transmitted from the object is determined as A in advance, the object location estimation apparatus may determine the distance between the object location estimation apparatus and the object based on an attenuation degree of the signal at the time of receiving.

However, the method of, performed by the object location estimation apparatus, determining the distance to the object based on the received signal is not limited to the above example. In another example, another method of determining the distance based on the received signal may be used.

In operation S240, when receiving the signals the set number of times or greater from the object, the object location estimation apparatus may estimate the location of the object based on the distance from the object based on each of the signals and the location on the driving path at the time of receiving each of the signals.

The object location estimation apparatus may record the location thereof at the time of receiving the signal from the object. Also, the object location estimation apparatus may determine whether the number of times that the signal is received from the object is equal to or greater than the preset number. For example, the object location estimation apparatus may determine whether the number of times that the signal is received from the object is equal to or greater than three.

Also, the object location estimation apparatus may estimate the location of the object by using the location of the object location estimation apparatus at the time of receiving each of the signals. This will be described in detail below with reference to FIG. 3.

In addition, when the location of the object is estimated, the object location estimation apparatus may be moved to the estimated location of the object. After moving to the location of the object, the object location estimation apparatus may provide the object with the service according to the service content requested by the terminal. For example, the object location estimation apparatus may provide the object with at least one of the refueling service, the location information providing service, the repairing service, or the charging service, but kinds of the services provided to the object are not limited thereto.

FIG. 3 is a diagram for describing a method of estimating an object location based on locations from which signals are received, performed by an object location estimation apparatus 320 according to an embodiment of the disclosure.

Referring to FIG. 3, the object location estimation apparatus 320 may initiate driving along the driving path when a call to the object is requested. In the embodiment of the disclosure, it will be described under an assumption that the object is a vehicle 310.

The object location estimation apparatus 320 may determine whether a signal received during the driving is transmitted from the vehicle 310, to which the call is requested. For example, the object location estimation apparatus 320 may select, from among signals transmitted from at least one vehicle, a signal including a car number of the vehicle 310 to which the call is requested as a valid signal. However, the car number is an example of identification information, by which the vehicle 310 may be identified, and the identification number is not limited to the car number.

Also, the object location estimation apparatus 320 according to the embodiment of the disclosure may only determine the signals received on the driving path having intensities of a threshold value or greater as the valid signals. The object location estimation apparatus 320 may improve the accuracy of estimating the location of the object, by determining the signals having the threshold intensities or greater as the valid signals.

In addition, the object location estimation apparatus 320 may drive through the driving path until the signals are received a preset number of times or more from the vehicle 310. Here, the preset number of times is assumed as three times. In addition, in FIG. 3, it is assumed that the object location estimation apparatus 320 receives signals from the vehicle 310 at points R1 (x1, y1), R2(x2, y2), and R3(x3, y3) on the driving path.

The object location estimation apparatus 320 may estimate the location of the vehicle 310 by applying a triangulation algorithm based on the locations of the points R1(x1, y1), R2(x2, y2), and R3(x3, y3) where the signals are received. When the location of the vehicle 310 is represented as L(x, y), a two-dimensional coordinate representing the location of the vehicle 310 may be determined by Equation below.

[Equations]

d1²=(x−x1)²+(y−y1)²

d2²=(x−x2)²+(y−y2)²

d3²=(x−x3)²+(y−y3)²

In Equation above, d1, d2, and d3 respectively denote distances from the vehicle 310 to the points R1(x1, y1), R2(x2, y2), and R3(x3, y3). Here, the distances between the vehicle 310 and the points R1(x1, y1), R2(x2, y2), and R3(x3, y3) may be determined according to the above description with reference to operation S230 of FIG. 2.

As the location of the vehicle 310 is estimated, the object location estimation apparatus 320 may move to the estimated location of the vehicle 310 to provide the vehicle 310 with the service.

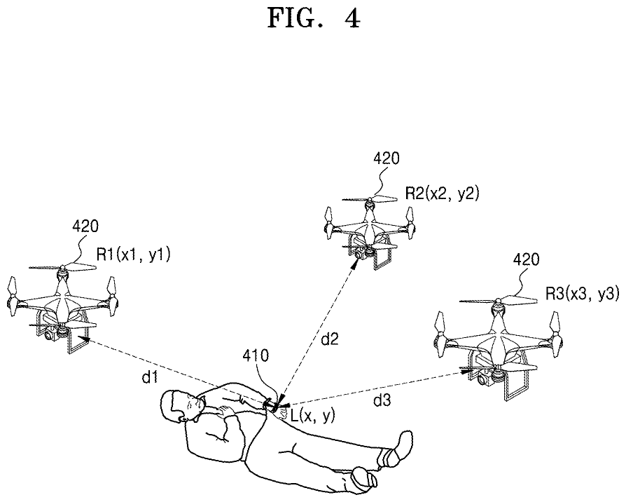

FIG. 4 is a diagram for describing a method of estimating a location of an object based on locations from which signals are received, performed by an object location estimation apparatus 420 according to another embodiment of the disclosure.

Referring to FIG. 4, the object location estimation apparatus 320 may initiate driving along the driving path when a call to the object is requested. In the embodiment of the disclosure, it will be described under an assumption that the object is a wearable device 410.

The object location estimation apparatus 420 may determine whether a signal received during the driving is transmitted from the wearable device 410, to which the call is requested. For example, the object location estimation apparatus 420 may determine whether the received signal includes a serial number of the wearable device 410. However, the serial number is an example of identification information, by which the wearable device 410 may be identified, and the identification number is not limited to the car number.

In addition, the object location estimation apparatus 420 may drive through the driving path until the signals are received the preset number of times or more from the wearable device 410. Also, in FIG. 4, it is assumed that the object location estimation apparatus 420 receives the signals from the wearable device 410 at the points R1 (x1, y1), R2(x2, y2), and R3(x3, y3) on the driving path.

The object location estimation apparatus 420 may estimate the location of the wearable device 410 by applying a triangulation algorithm based on the locations of the points R1(x1, y1), R2(x2, y2), and R3(x3, y3) where the signals are received. Here, the method of, performed by the object location estimation apparatus 420, estimating the location of the wearable device 410 is the same as that described above with reference to FIG. 3, and thus, detailed descriptions thereof are omitted.

FIG. 5 is a diagram for describing a method of determining a driving path by using a training network model 530, performed by an object location estimation apparatus 510 according to an embodiment of the disclosure.

Referring to FIG. 5, the object location estimation apparatus 510 may store a learning network model 530 generated in advance. However, the learning network model 530 may be stored in an external device. For example, the learning network model 530 may be stored in the server described above with reference to FIG. 1.

In the embodiment of the disclosure, the learning network model 530 may include a plurality of layers trained in advance such that a driving path 540 may be calculated based on input information 520 including user information, history information about previous location of the object, etc. Here, the user information may include at least one of user address or an object using time. However, the user information is not limited to the above examples. In addition, at least one parameter defined for each of the plurality of layers may be determined to extract characteristic information that is necessary for calculating the driving path 540 from the input information 520.

When receiving a call request to the object, the object location estimation apparatus 510 may input user information, history information, etc. about the object into the learning network model 530. The driving path 540 output from the learning network model 530 may reflect the user information, the history information, etc. For example, when a user's residence is in a zone A and parking time (vehicle usage ending time) is 10 o'clock, the driving path 540 output from the learning network model 530 may be set by applying a weight to a parking zone that is closer to the zone A, in which the residence of the user is located, and is mainly empty around 10 o'clock. According to another example, when a parking zone that the user previously has parked his/her car is in a zone B, the driving path 540 output from the learning network model 530 may be set by applying a weight to the zone B.

The object location estimation apparatus 510 according to the embodiment drives through the driving path 540 determined through the learning network model 530 and thus may effectively estimate the object location.

FIG. 6 is a flowchart illustrating a method of estimating a location of the object according to another embodiment of the disclosure.

In operation S610, an object location estimation apparatus may obtain identification information of an object and information about a target area included in a call request to the object transmitted from a terminal.

For example, the object location estimation apparatus may receive a call request to the object, when a user of the object tags the terminal to an NFC tag. Here, the object location estimation apparatus may directly receive the call request through the NFC tagging, but when the call request is transmitted through a server managing a plurality of NFC tags, the object location estimation apparatus may receive transfer of the information included in the call request.

The call request may include information about the target area, that is, a region where the NFC tag is attached, and identification information of the object. However, one or more embodiments are not limited to the above example, that is, the target area may be estimated by using an identification number of the NFC tag, instead of the information about the target area.

In addition, the call request may be received through an RFID method or a QR code method, as well as the NFC method.

In operation S620, the object location estimation apparatus may initiate driving to the target area.

The object location estimation apparatus according to the embodiment may initiate driving along a driving path that is set to the target area.

In operation S630, the object location estimation apparatus may obtain at least one image of the object at the target area during the driving.

The object location estimation apparatus may recognize at least one object during the driving and capture an image of the recognized at least one object. However, one or more embodiments are not limited thereto, according to another example, when there is no sensing unit through which the at least one object may be recognized, the object location estimation apparatus may capture images at a predetermined time interval during the driving to the target area.

In operation S640, the object location estimation apparatus may estimate the object location by comparing identification information recognized from the image of at least one object and the obtained identification information of the object.

The object location estimation apparatus according to the embodiment may recognize the identification information of the object by applying an OCR method to the obtained at least one object image. However, one or more embodiments are not limited to thereto, that is, the method of recognizing the identification information of the object by the object location estimation apparatus is not limited to the above example.

The object location estimation apparatus may estimate the location of the object, to which the call is requested, by comparing the identification information of the object obtained when receiving the call request with the identification information recognized from the at least one object image. For example, the object location estimation apparatus may estimate the object location based on a location of the object location estimation apparatus at the time of capturing an image, from which the identification information identical with the identification of the object is recognized.

FIG. 7 is a diagram for describing a method of estimating a location of the object through NFC tagging and image recognition, performed by an object location estimation apparatus 710 according to an embodiment.

Referring to FIG. 7, the object location estimation apparatus 710 may receive a call request from a terminal to an object. In the embodiment, it is assumed that the object is a vehicle 720. For example, the object location estimation apparatus 710 may receive a call request to the vehicle 720 when a user of the object tags the terminal to one (e.g., 732) of a plurality of NFC tags 732, 734, 736, and 738. The call request may include information about a target area 730 corresponding to the NFC tag 732, to which the terminal is tagged, and identification information of the vehicle 720.

When receiving the call request, the object location estimation apparatus 710 may initiate driving in the target area 730. During the driving, the object location estimation apparatus 710 may obtain an image of at least one vehicle located in the target area. The object location estimation apparatus 710 may estimate a location of the vehicle 720 by comparing a car number recognized from the obtained image of at least one object with a car number 750 of the vehicle 720, to which the call is requested. For example, the object location estimation apparatus 710 may estimate the location of the vehicle 720 based on a location of the object location estimation apparatus 710 at the time of capturing the image, from which the car number identical with the car number 750 is recognized.

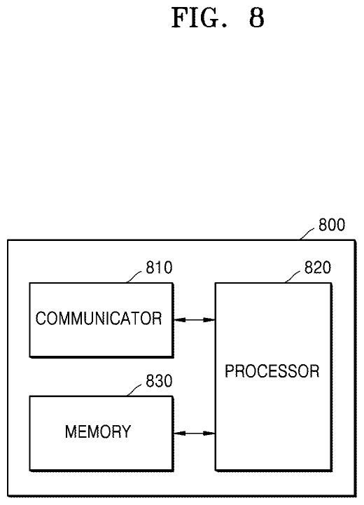

FIG. 8 is a block diagram of an object location estimation apparatus 800 according to an embodiment of the disclosure.

Referring to FIG. 8, the object location estimation apparatus 800 may include a communicator 810, a processor 820, and an outputter 830.

The communicator 810 may receive a call request from a terminal to an object. For example, the communicator 810 may directly receive a call request from the terminal to the object or may receive information about the call request transmitted from the terminal via a server. Also, the communicator 810 may receive signals from the object the preset number of times or more, during the driving of the object location estimation apparatus 800.

The processor 820 may include one or more cores (not shown) and a connection path (e.g., bus, etc.) transmitting/receiving signals to/from a graphics processing unit (not shown) and/or other elements.

According to the embodiment of the disclosure, the processor 820 may execute the operations of the object location estimation apparatus described above with reference to FIGS. 1 to 7.

For example, the processor 820 may initiate driving along the driving path when receiving a call request from a terminal to the object. The processor 820 may determine a distance from the object based on the signal transmitted from the object during the driving along the driving path. Also, when receiving the signals from the object the set number of times or greater, the processor 820 may estimate the location of the object based on the distance from the object based on each of the signals and the location on the driving path at the time of receiving each of the signals.

In another example, the processor 820 may obtain identification information of an object and information about a target area included in a call request to the object transmitted from a terminal, and may initiate driving to the target area. The processor 820 may estimate the object location by comparing identification information recognized from the image of at least one object obtained during the driving with the obtained identification information of the object.

In addition, the processor 820 may further include a random access memory (RAM, not shown) and a read only memory (ROM, not shown) that temporarily and/or permanently store signals (or data) processed in the processor 820. Also, the processor 820 may be implemented as a system on chip (SoC) including at least one of a graphic processor, a RAM, and a ROM.

The memory 830 may store one or more instructions allowing operations of the object location estimation apparatus described above with reference to FIGS. 1 to 7 to be executed.

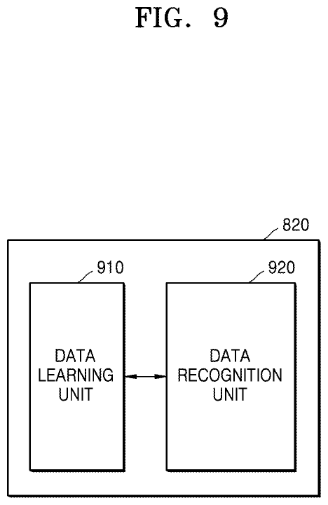

FIG. 9 is a diagram for describing the processor 820 according to the embodiment of the disclosure.

Referring to FIG. 9, the processor 820 according to the embodiment of the disclosure may include a data learning unit 910 and a data recognition unit 920.

The data learning unit 910 may learn criteria for determining the driving path for estimating a location of the object based on user information and history information about previous location of the object.

The data recognition unit 920 may determine the driving path corresponding to the input user information and the history information, based on the criteria trained by the data learning unit 910.

At least one of the data learning unit 910 or the data recognition unit 920 may be manufactured in the form of at least one hardware chip that is mounted in the object location estimation apparatus. For example, at least one of the data learning unit 910 and the data recognition unit 920 may be manufactured as a hardware chip exclusive for artificial intelligence (AI), or may be manufactured as a part of an existing universal processor (e.g., a central processing unit (CPU) or an application processor) or a graphics-only processor (e.g., graphics processing unit (GPU)) to be mounted in the various object location estimation apparatuses.

In this case, the data learning unit 910 and the data recognition unit 920 may be mounted in one apparatus, or may be respectively mounted in separate apparatuses. For example, one of the data learning unit 910 or the data recognition unit 920 may be included in an object location estimation apparatus and the other may be included in a server. Also, the data learning unit 910 and the data recognition unit 920 may communicate with each other through wires or wirelessly, so that model information established by the data learning unit 910 may be provided to the data recognition unit 920 and data input to the data recognition unit 920 may be provided to the data learning unit 910 as additional learning data.

In addition, at least one of the data learning unit 910 or the data recognition unit 920 may be implemented as a software module. When at least one of the data learning unit 910 and the data recognition unit 920 is implemented as a software module (or a programming module including instructions), the software module may be stored in a non-transitory computer-readable medium. In addition, in this case, the at least one software module may be provided by an operating system (OS), or a predetermined application. Otherwise, a part of the at least one software module is provided by the OS or the remaining part of the at least one software module may be provided by a predetermined application.

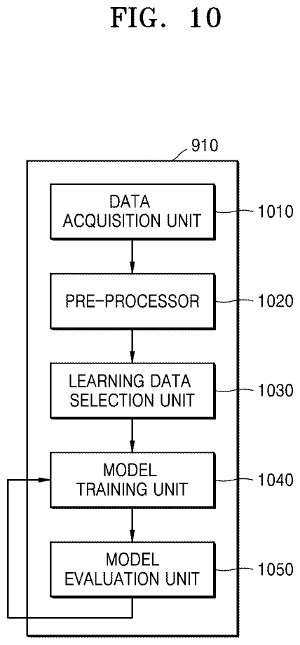

FIG. 10 is a block diagram of the data learning unit 910 according to the embodiment of the disclosure.

Referring to FIG. 10, the data learning unit 910 according to some embodiments of the disclosure may include a data acquisition unit 1010, a pre-processor 1020, a learning data selection unit 1030, a model training unit 1040, and a model evaluation unit 1050. However, one or more embodiments of the disclosure are not limited thereto, that is, the data learning unit 910 may include less or more elements than the above-stated elements.

The data acquisition unit 1010 may acquire at least one piece of user information and history information received by the object location estimation apparatus as learning data.

The pre-processor 1020 may pre-process the obtained at least one piece of user information and history information to be used in learning for determining the driving path. The pre-processor 1020 may process the at least one piece of obtained user information and history information in a preset format, so that the model training unit 1040 that will be described later may use the at least one piece of user information and history information obtained for learning.

The learning data selection unit 1030 may select user information and history information that are necessary for the learning, from the pre-processed data. The selected user information and history information may be provided to the model training unit 1040. The learning data selection unit 1030 may select the user information and history information necessary for learning, from among the pre-processed user information and history information, according to the set criterion.

The model training unit 1040 may learn the criterion about what kind of information, from among the user information and the characteristic information of the history information, is used to determine the driving path in each of the plurality of layers in the learning network model. For example, the model training unit 1040 may learn a first criterion about which of the plurality of layers included in the learning network model is used to extract the characteristic information that is used to determine the driving path. Here, the first criterion may include types, the number, or levels of characteristics in the user information and the history information used to determine the driving path by the object location estimation apparatus using the learning network model.

According to one or more embodiments of the disclosure, when there are a plurality of data recognition models established in advance, the model training unit 1040 may determine a data recognition model, in which input learning data and basic learning data are highly related to each other, as the data recognition model to learn. In this case, the basic learning data may be classified in advance according to data types, and the data recognition model may be established in advance for each data type. For example, the basic learning data may be classified in advance based various criteria such as a region where the learning data is generated, a time of generating the learning data, a size of the learning data, genre of the learning data, a producer of the learning data, kinds of objects included in the learning data, etc.

Also, the model training unit 1040 may train the data recognition model through, for example, reinforcement learning which uses feedback as to whether additional information determined according to the training is correct.

Also, when the data recognition model is trained, the model training unit 1040 may store the trained data recognition model. In this case, the model training unit 1040 may store the trained data recognition model in a memory of the device including the data recognition unit 1020. Alternatively, the model training unit 1040 may store the trained data recognition model in a memory of the device including the data recognition unit 1020 that will be described later. Alternatively, the model training unit 1040 may store the trained data recognition model in a memory of a server that is connected to the terminal through a wired network or a wireless network.

In this case, the memory storing the trained data recognition model may also store, for example, commands or data related to at least one other element of the terminal. Also, the memory may store software and/or programs. The program may include, for example, a kernel, middleware, an application programming interface (API), and/or an application program (or “application”), etc.

The model evaluation unit 1050 may input evaluation data to the data recognition model, and when a recognition result output from the evaluation data does not satisfy a predetermined criterion, the model evaluation unit 1050 may allow the model learning unit 1040 to train again. In this case, the evaluation data may be set in advance to evaluate the data recognition model. Here, the evaluation data may include a matching ratio between additional information corresponding to an object determined based on the learning network model and additional information corresponding to the actual object.

In addition, when there are a plurality of learning network models, the model evaluation unit 1050 evaluates whether the predetermined criterion is satisfied with respect to each of the learning network models and may determine the model satisfying the predetermined standard as a final learning network model.

At least one of the data acquisition unit 1010, the pre-processor 1020, the learning data selection unit 1030, the model training unit 1040, and the model evaluation unit 1050 in the data learning unit 1010 may be manufactured as at least one hardware chip and mounted in the device. For example, at least one of the data acquisition unit 1010, the pre-processor 1020, the learning data selection unit 1030, the model training unit 1040, or the model evaluation unit 1050 may be manufactured as a hardware chip exclusive for the AI, or may be manufactured as a part of an existing universal processor (e.g., a CPU or an application processor) or a graphics-only processor (e.g., a GPU) to be mounted in various devices described above.

Also, the data acquisition unit 1010, the pre-processor 1020, the learning data selection unit 1030, the model training unit 1040, and the model evaluation unit 1050 may be provided in one device, or may be respectively provided in separate devices. For example, some of the data acquisition unit 1010, the pre-processor 1020, the learning data selection unit 1030, the model training unit 1040, and the model evaluation unit 1050 may be included in the device, and some other may be included in a server.

Also, at least one of the data acquisition unit 1010, the pre-processor 1020, the learning data selection unit 1030, the model training unit 1040, and the model evaluation unit 1050 may be implemented as a software module. When at least one of the data acquisition unit 1010, the pre-processor 1020, the learning data selection unit 1030, the model training unit 1040, and the model evaluation unit 1050 is implemented as a software module (or a program module including instructions), the software module may be stored in a non-transitory computer-readable medium. In addition, in this case, the at least one software module may be provided by an operating system (OS), or a predetermined application. Otherwise, a part of the at least one software module is provided by the OS or the remaining part of the at least one software module may be provided by a predetermined application.

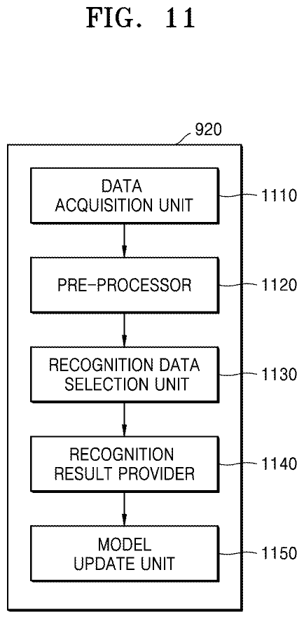

FIG. 11 is a block diagram of the data recognition unit 920 according to the embodiment of the disclosure.

Referring to FIG. 11, the data recognition unit 920 according to some embodiments of the disclosure may include a data acquisition unit 1110, a pre-processor 1120, a recognition data selection unit 1130, a recognition result provider 1140, and a model update unit 1150.

The data acquisition unit 1110 may obtain at least one piece of user information and history information that are necessary for determining the driving path for estimating the object location, and the pre-processor 1120 may pre-process the obtained information such that the obtained at least one piece of user information and history information obtained may be used to determine the driving path. The pre-processor 1120 may process the obtained user information and history information in a preset format, so that the recognition result provider 1140 that will be described later may use the obtained user information and history information to determine the driving path for estimating the object location.

The recognition data selection unit 1130 may select user information and history information that are necessary for determining the driving path, from the pre-processed data. The selected user information and history information may be provided to the recognition result provider 1140.

The recognition result provider 1140 may determine the driving path for estimating the object location by applying the selected user information and history information to the learning network model according to the embodiment of the disclosure.

The model update unit 1150 may provide the model training unit 1040 described above with reference to FIG. 10 with information about evaluation so that a parameter of a classification network or at least one characteristic extracting layer included in the learning network model, etc., based on evaluation about the result of determining the driving path provided from the recognition result providing unit 1140.

At least one of the data acquisition unit 1110, the pre-processor 1120, the recognition data selection unit 1130, the recognition result provider 1140, or the model update unit 1150 in the data recognition unit 920 may be manufactured as at least one hardware chip and mounted in the device. For example, at least one of the data acquisition unit 1110, the pre-processor 1120, the recognition data selection unit 1130, the recognition result provider 1140, or the model update unit 1150 may be manufactured as a hardware chip exclusive for AI, or may be manufactured as a part of an existing universal processor (e.g., a CPU or an application processor) or a graphics-only processor (e.g., GPU) to be mounted in the various devices.

Also, the data acquisition unit 1110, the pre-processor 1120, the recognition data selection unit 1130, the recognition result provider 1140, or the model update unit 1150 may be provided in one device, or may be respectively provided in separate devices. For example, some of the data acquisition unit 1110, the pre-processor 1120, the recognition data selection unit 1130, the recognition result provider 1140, and the model update unit 1150 may be included in the device, and some other may be included in a server.

Also, at least one of the data acquisition unit 1110, the pre-processor 1120, the recognition data selection unit 1130, the recognition result provider 1140, or the model update unit 1150 may be implemented as a software module. When at least one of the data acquisition unit 1110, the pre-processor 1120, the recognition data selection unit 1130, the recognition result provider 1140, and the model update unit 1150 is implemented as a software module (or a program module including instructions), the software module may be stored in a non-transitory computer-readable medium. In addition, in this case, the at least one software module may be provided by an operating system (OS), or a predetermined application. Otherwise, a part of the at least one software module is provided by the OS or the remaining part of the at least one software module may be provided by a predetermined application.

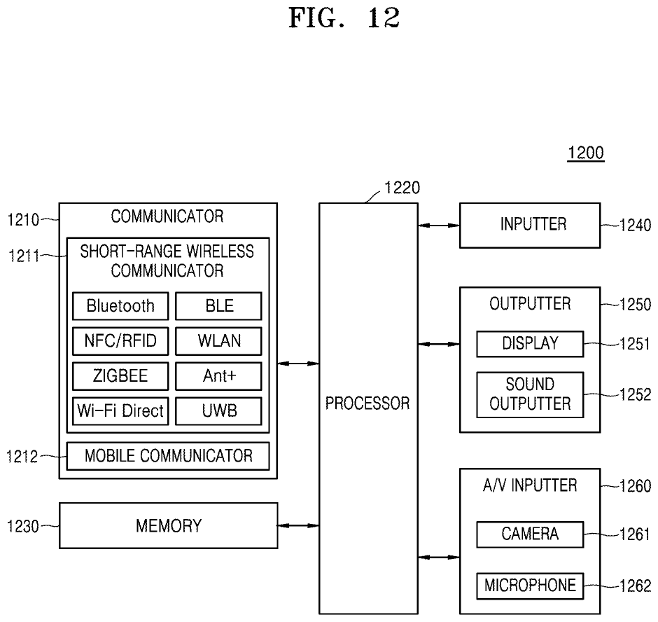

FIG. 12 is a block diagram of an object location estimation apparatus 1200 according to another embodiment of the disclosure.

Referring to FIG. 12, the object location estimation apparatus 1200 according to an embodiment of the disclosure may further include an inputter 1240, an outputter 1250, and an A/V inputter 1260, in addition to a communicator 1210, a processor 1220, and a memory 1230 corresponding to the communicator 810, the processor 820, and the memory 830 of FIG. 8.

The communicator 1210 may receive information about a call request to an object. In addition, the communicator 1210 may receive a signal sent from the object.

The communicator 1210 may include one or more elements allowing communication with an external server or other external devices (e.g., object). For example, the communicator 1210 may include a short-range wireless communicator 1211 and a mobile communicator 1212.

The short-range wireless communicator 1211 may include, but is not limited to, a Bluetooth communicator, a Bluetooth low energy (BLE) communicator, an NFC/radio frequency identification (RFID) communicator, a wireless local area network (WLAN) communicator, a ZigBee communicator, an infrared data association (IrDA) communicator, a Wi-Fi direct (WFD) communicator, an ultra wideband (UWB) communicator, an Ant+ communicator, etc.

The mobile communicator 1212 may transmit/receive a wireless signal to/from at least one of a base station, an external terminal, or a server through a mobile communication network.

The processor 1220 may generally control overall operations of the object location estimation apparatus 1200 and flow of signals among internal components of the object location estimation apparatus 1200, and process the data. For example, the processor 1220 may execute programs (one or more instructions) stored in the memory 1230 to control the communicator 1210, the inputter 1240, the outputter 1250, the A/V inputter 1260, etc.

The processor 1220 according to the embodiment of the disclosure corresponds to the processor 820 of FIG. 8, and thus, detailed descriptions thereof are omitted.

The memory 1230 may store programs (e.g., one or more instructions, learning network model) for processing and controlling the processor 1220, and may store the data (e.g., additional information) input into the object location estimation apparatus 1200 or output from the object location estimation apparatus 1200.

The putter 1240 is a unit through which data for controlling the object location estimation apparatus 1200 is input by the user. For example, the inputter 1240 may include, but is not limited to, a keypad, a dome switch, a touch pad (a capacitive overlay type, a resistive overlay type, an infrared beam type, a surface acoustic wave type, an integral strain gauge type, a piezoelectric type, etc.), a jog wheel, a jog switch, or the like.

The outputter 1250 may output information about the estimated object location in the form of an audio signal or a video signal, and the outputter 1250 may include a display 1251 and a sound outputter 1252.

The display 1251 is configured to display and output information processed by the object location estimation apparatus 1200. When the display 1251 and a touch pad are configured as a touch screen in a layered structure, the display 1251 may be used as an input device, in addition to as an output device.

The sound outputter 1252 outputs audio data transmitted from the communicator 1210 or stored in the memory 1230. When the object location is estimated, the sound outputter 1252 may output information about the estimated object location.

The A/V input unit 1260 is for inputting an audio signal or a video signal, and may include a camera 1261, a microphone 1262, etc.

The camera 1261 captures an image within a recognition range. For example, during driving along the driving path, the camera 1261 may capture an image of at least one object. The image captured by the camera 1261 according to an embodiment of the disclosure is processed by the processor 1220 and displayed on the display 1231.

The microphone 1262 may receive a voice input of the user regarding the call of the object. Also, in another example, the microphone 1262 may sense ambient sound in order to avoid obstacles during the driving.

In addition, the configuration of the object location estimation apparatus 1200 shown in FIG. 12 is an example, and each of the components in the object location estimation apparatus 1200 may be combined, added, or omitted according to a specification of the object location estimation system that is implemented. That is, if necessary, two or more components may be combined as one or one component may be divided as two or more components. Also, functions for each element (or module) are to explain the embodiment of the disclosure and each specific operation or device do not limit the authority of the disclosure.

The terminology used herein is for the purpose of describing particular embodiments and is not intended to limit the disclosure.

It will be evident to those skilled in the art that various implementations based on the technical spirit of the disclosure are possible in addition to the disclosed embodiments. In addition, the above embodiments of the disclosure are classified for convenience of description, and the embodiments of the disclosure may be combined as necessary.

Apparatuses according to the embodiments may include a processor, a memory for storing program data and executing it, a permanent storage unit such as a disk drive, a communications port for handling communications with external devices, and user interface devices, including a touch panel, keys, buttons, etc. When software modules or algorithms are involved, these software modules may be stored as program commands or computer-readable code executable on a processor on a computer-readable recording medium. Examples of the computer-readable recording medium include magnetic storage media (e.g., ROM, RAM, floppy disks, hard disks, etc.), and optical recording media (e.g., CD-ROMs or Digital Versatile Discs (DVDs)). The computer-readable recording medium may also be distributed over network coupled computer systems so that the computer-readable code is stored and executed in a distributive manner. This media may be read by the computer, stored in the memory, and executed by the processor.

The embodiments of the disclosure may be described in terms of functional block components and various processing steps. The functional blocks may be implemented as various numbers of hardware and/or software configurations executing certain functions. For example, the embodiments of the disclosure may adopt direct circuit configurations such as a memory, processing, logic, look-up table, etc. that may perform various functions according to control of one or more microprocessors or other control devices. Similarly, where the elements are implemented using software programming or software elements, the embodiments of the disclosure may be implemented with any programming or scripting language such as C, C++, Java, assembler language, or the like, with the various algorithms being implemented with any combination of data structures, objects, processes, routines or other programming elements. The functional aspects may be implemented in algorithms that are executed on one or more processors. Also, the embodiments of the disclosure may employ any number of techniques according to the related art for electronics configuration, signal processing and/or control, data processing, and the like.

1. A method of estimating an object location, the method comprising:
when a call request to an object is received from a terminal, initiating driving along a driving path;
receiving a signal from the object during driving along the driving path;
determining a distance from the object based on the signal transmitted from the object; and
when the signal is received from the object a set number of times or greater during the driving, estimating a location of the object based on the distance from the object determined based on each signal and a location on the driving path at a time of receiving each signal.

2. The method of claim 1, further comprising determining the driving path, based on history information about the location of the object before receiving the call request.

3. The method of claim 1, further comprising determining the driving path by using a learning network model that is generated in advance based on user information and history information about the location of the object before receiving the call request, the user information including at least one of an address of a user of the object or an object using time.

4. The method of claim 1, wherein the estimating of the object location comprises determining whether a signal having a threshold intensity or greater is received the set number of times or more from the object during the driving.

5. The method of claim 1, wherein the signal comprises identification information of the object, and
the method further comprises determining whether a signal received during the driving along the driving path includes the identification information of the object.

6. The method of claim 1, further comprising, when a server receives the call request from the terminal, receiving the call request from the server.

7. An apparatus for estimating an object location, the apparatus comprising:
a communicator;
a memory storing one or more instructions; and
a processor configured to execute the one or more instructions stored in the memory,
wherein the processor is further configured to execute the one or more instructions to:
when receiving a call request to an object from a terminal, initiate driving along a driving path;
receive a signal from the object via the communicator during driving along the driving path;
determine a distance from the object based on the signal transmitted from the object; and
when the signal is received from the object a set number of times or greater during the driving, estimate a location of the object based on the distance from the object determined based on each signal and a location on the driving path at a time of receiving each signal.

8. The apparatus of claim 7, wherein the processor is further configured to execute the one or more instructions to determine the driving path based on history information about the location of the object before receiving the call request.

9. The apparatus of claim 7, wherein the processor is further configured to execute the one or more instructions to determine the driving path by using a learning network model that is generated in advance based on user information and history information about the location of the object before receiving the call request, the user information including at least one of an address of a user of the object or an object usage time.

10. The apparatus of claim 7, wherein the processor is further configured to execute the one or more instructions to determine whether a signal having a threshold intensity or greater is received the set number of times or more from the object during the driving.

11. The apparatus of claim 7, wherein the signal comprises identification information of the object, and
the processor is further configured to execute the one or more instructions to determine whether a signal received during the driving along the driving path includes the identification information of the object.

12. The apparatus of claim 7, wherein the processor is further configured to execute the one or more instructions to, when a server receives the call request from the terminal, receive the call request from the server.

13. A computer program product comprising a computer-readable recording medium having embodied thereon a program for executing the operations of:
when receiving a call request to an object from a terminal, initiating driving along a driving path;
receiving a signal from the object during driving along the driving path; and
when the signal from the object is received a set number of times or greater during the driving, estimating the location of the object based on a location on the driving path at a time of receiving each signal.
